(19) United States
(12) Patent Application Publication
(10) Pub. No.: US 2019/0331769 A1
(43) Pub. Date: Oct. 31, 2019

(54) OPTICAL SENSOR AND ELECTRONIC APPARATUS

(71) Applicant: SHARP KABUSHIKI KAISHA, Sakai City (JP)

(72) Inventors: SHOHEI KAMADA, Sakai City (JP); NORIKAZU OKADA, Sakai City (JP)

(21) Appl. No.: 16/380,348

(22) Filed: Apr. 10, 2019

(30) Foreign Application Priority Data
Apr. 27, 2018 (JP) 2018-087342

(51) Int. Cl. G01S 7/481; G01S 17/08; G01B 11/14

(52) U.S. Cl. CPC G01S 7/4815; G01B 11/14; G01S 17/08

(57) ABSTRACT

An optical sensor includes a light-emitting element unit that emits a signal beam having a predetermined spread centered at a direction of emission and a light-detecting element unit that receives a signal beam reflected by an object to be measured. The light-emitting element unit has a plurality of light-emitting spots including a first light-emitting element and a second light-emitting element that are different in angle of beam spread of the signal beam from each other. Of these light-emitting elements, the second light-emitting element emits a second signal beam that is narrower in angle of beam spread than the first light-emitting element. The optical sensor combines these first and second light-emitting elements to detect the distance to the object to be measured on the basis of a signal beam received by the light-detecting element unit.

### BACKGROUND

### 1. Field

The present disclosure relates to an optical sensor and an electronic apparatus including this optical sensor.

### 2. Description of the Related Art

Optical sensors have been widely used to detect the presence or absence of an object and detect the distance to the object. Known examples of these types of optical sensor include range image sensors such as those described in Japanese Unexamined Patent Application Publication No. 2012-47500, Japanese Unexamined Patent Application Publication No. 2012-137469, and the like.

The range image sensor disclosed in Japanese Unexamined Patent Application Publication No. 2012-47500 is configured to form spots of projected light on a physical object with a plurality of split beams, measure the distance on the basis of the inclinations of segments defined by the spots of projected light, and generates a spatially-resolved image of the physical object. Further, the image-capturing device of Japanese Unexamined Patent Application Publication No. 2012-137469 is proposed so that resolving power in an in-plane direction perpendicular to an optical axis is rendered variable in capturing a three-dimensional shape such as the surface shape of an object.

A method such as that disclosed in Japanese Unexamined Patent Application Publication No. 2012-47500 for generating a spatially-resolved image of an object makes it necessary to perform detection over the entire range of a target space by moving all spots of projected light. This undesirably makes it inevitable for spatial scanning to take longer time and for the spots of projected light to consume a larger amount of electricity.

Further, in-plane direction resolving power such as that disclosed in Japanese Unexamined Patent Application Publication No. 2012-137469 makes it necessary to combine a plurality of optical elements for a resolving power variable program, although it makes it possible to narrow down a range of detection. This undesirably invites increases in system complexity and power consumption.

It is desirable to provide an optical sensor that has improved resolving power with a simple configuration and is capable of detection with low power consumption and at high speeds and an electronic apparatus including this optical sensor.

### SUMMARY

According to an aspect of the disclosure, there is provided an optical sensor including: a light-emitting element unit that emits a signal beam having a predetermined spread centered at a direction of emission; and a light-detecting element unit that receives a signal beam reflected by an object to be measured, the optical sensor detecting a distance to the object to be measured on the basis of a signal beam received by the light-detecting element unit, wherein the light-emitting element unit has a plurality of light-emitting spots arrayed, and the light-emitting spots include a first light-emitting element and a second light-emitting element that are different in angle of beam spread of the signal beam from each other.

According to an aspect or the disclosure, there is provided an electronic apparatus including the optical sensor thus configured.

### BRIEF DESCRIPTION OF THE DRAWINGS

FIG. 1 is an explanatory diagram schematically showing an optical system of an optical sensor according to Embodiment 1 of the present disclosure;

FIG. 2 is an explanatory diagram showing ranges of irradiation by a light-emitting element unit of the optical sensor;

FIG. 3 is an explanatory diagram showing ranges of irradiation by second light-emitting elements of the optical sensor;

FIG. 4 is a cross-sectional view showing a structure of a surface-emitting semiconductor laser as a light-emitting spot of an optical sensor according to Embodiment 2 of the present disclosure;

FIG. 5 is an explanatory diagram schematically showing how first light-emitting elements of the optical sensor are driven;

FIG. 6 is an explanatory diagram schematically showing how second light-emitting elements of the optical sensor are driven;

FIG. 7 is an explanatory diagram showing a far-field pattern of light emitted by light-emitting spots of the optical sensor;

FIG. 8 is an explanatory diagram showing a configuration of an optical sensor according to Embodiment 3 of the present disclosure;

FIG. 9 is an explanatory diagram showing a configuration of a light-emitting element unit of the optical sensor;

FIGS. 10A and 10B are explanatory diagrams each showing an example of an electronic apparatus to which the optical sensor is applied;

FIG. 11 is an explanatory diagram schematically showing how first light-emitting elements of an optical sensor according to Embodiment 4 of the present disclosure are driven;

FIG. 12 is an explanatory diagram schematically showing how second light-emitting elements of the optical sensor are driven; and

FIG. 13 is an explanatory diagram showing a configuration of an optical sensor according to Embodiment 5 of the present disclosure.

### DESCRIPTION OF THE EMBODIMENTS

Optical sensors 1 according to embodiments of the present disclosure are described below with reference to the drawings.

### Embodiment 1

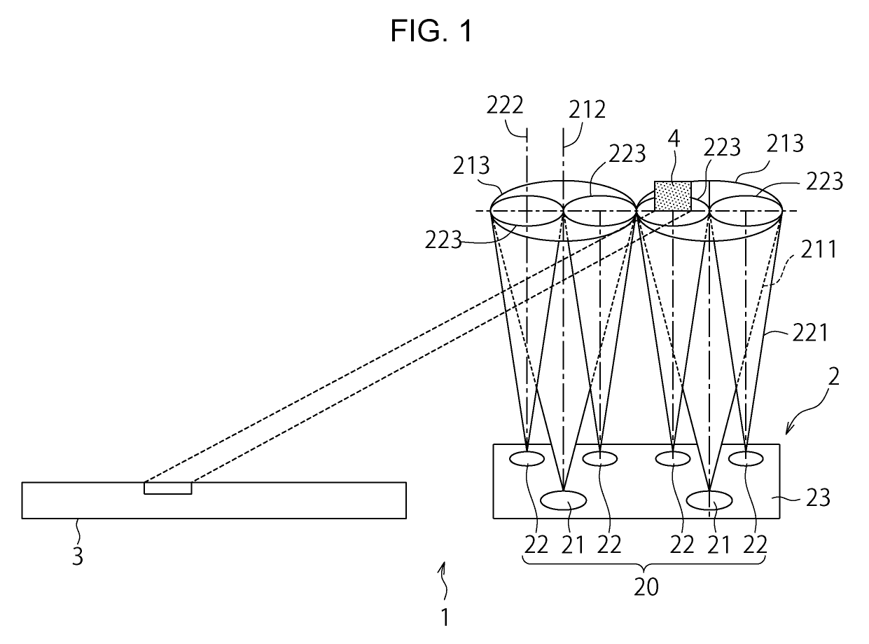

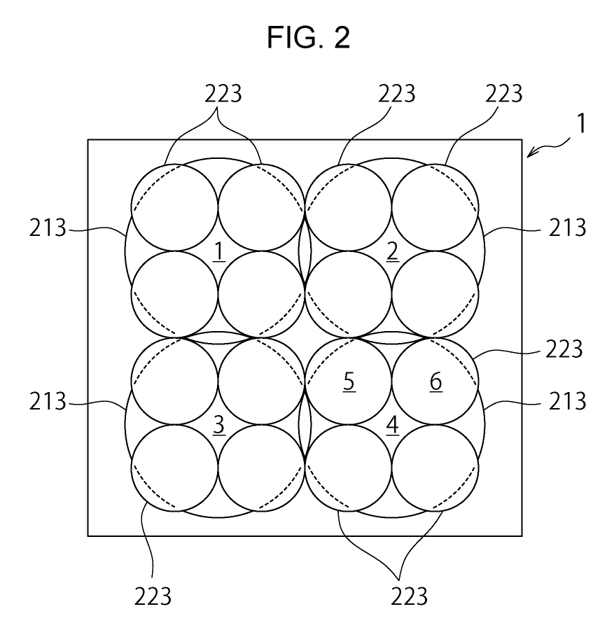

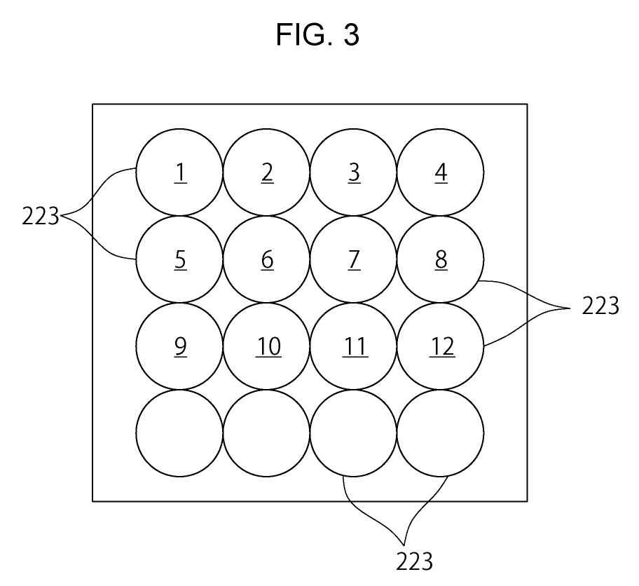

FIGS. 1 to 3 pertain to an optical sensor 1 according to Embodiment 1 of the present disclosure. FIG. 1 is an explanatory diagram schematically showing an optical system of the optical sensor 1. FIG. 2 is an explanatory diagram showing ranges of irradiation 213 and 223 by a light-emitting element unit 2 of the optical sensor 1. FIG. 3 is an explanatory diagram showing ranges of irradiation 223 by second light-emitting elements 22 of the second light-emitting element unit 2.

The optical sensor 1 includes a light-emitting element unit 2 that emits a signal beam and a light-detecting element unit 3 that receives a signal beam reflected by an object to be measured 4, and detects the distance to the object to be measured 4.

The light-emitting element unit 2 includes a plurality of light-emitting spots 20 arrayed on the same plane. A signal beam has a predetermined spread centered at a direction of emission thereof, and the light-emitting spots 20 include a first light-emitting element 21 and a second light-emitting element 22 that are different in angle of beam spread of the signal beam from each other.

The first light-emitting element 21 emits a first signal beam 211. Further, the second light-emitting elements 22 emits a second signal beam 221. The first light-emitting element 21 may emit a first signal beam 211 that is wider in angle of beam spread than the second light-emitting element 22. The following refers to a combination of the first light-emitting element 21 and the second light-emitting element 22 as “light-emitting spots 20”.

As shown in FIG. 1, the first light-emitting element 21 and the second light-emitting element 22 are arrayed on an identical chip 23. The chip 23 has its upper surface constituting a plane that is orthogonal to an optical axis 212 of the first signal beam 211 and an optical axis 222 of the second signal beam 221. A plurality of the first light-emitting elements 21 and a plurality of the second light-emitting elements 22 are arrayed on the chip 23.

The light-detecting element unit 3 receives a first signal beam 211 or a second signal beam 221 from the light-emitting spots 20 and outputs a received-light signal. The light-detecting element unit 3 is disposed on a plane that is orthogonal to the optical axis 212 of the first signal beam 211 and the optical axis 222 of the second signal beam 221.

This optical sensor 1 enables splitting of spatial scanning to be performed by switching the emission of light from the light-emitting spots 20 in an optical system that measures the distance to the object to be measured 4. That is, spatial scanning is performed with a combination of the first light-emitting elements 21, which emit first signal beams 211 that are wide in angle of beam spread, and the second light-emitting elements 22, which emit second signal beams 221 that are narrower in angle of beam spread than the first signal beams 211.

As shown in FIG. 1, a range of irradiation 223 by a second light-emitting element 22 that is narrow in angle of beam spread overlaps a range of irradiation 213 by a first light-emitting element 21 that is wide in angle of beam spread. Further, the inside of a range of irradiation 213 by a single first light-emitting element 21 encompasses ranges of irradiation 223 by a plurality of second light-emitting elements 22. In such an optical system, rough measurements taken with the first light-emitting elements 21, which are wide in angle of beam spread, and fine measurements taken with the second light-emitting elements 22, which are narrow in angle of beam spread, are combined, and spatial scanning is done by driving the first light-emitting elements 21 and the second light-emitting elements 22 in sequence.

With attention focused on the ranges of irradiation 213 and 223, for example, as shown in FIG. 2, a range of irradiation 213 by a single first light-emitting element 21 includes ranges of irradiation 223 by four second light-emitting elements 22. FIG. 3 is an explanatory diagram showing only ranges of irradiation 223 by second light-emitting elements 22 in the same form of placement as FIG. 2.

Assume a case of detecting an object to be measured 4 by driving only second light-emitting elements 22. In FIG. 3, in order to find as object to be measured 4 that is present in the twelfth range of irradiation 223, it is necessary to detect the object to be measured 4 by emitting light a total of twelve times starting from the first second light-emitting element 22. In this case, since a plurality of second light-emitting elements 22 are driven in order, there is such a demerit that it takes a substantial amount of time to detect the object to be measured 4.

On the other hand, as shown in FIG. 2, the optical sensor 1 according to Embodiment 1 drives the first light-emitting elements 21, which are wide in angle of beam spread, first to perform spatial scanning from the first to fourth range of irradiation 213 in sequence. Accordingly, rough measurements are taken with the first light-emitting elements 21, which are wide in angle of beam spread, and the location of the object to be measured 4 is identified with low resolving power. After that, the second light-emitting element 22, which are narrow in angle of beam spread, are driven to perform finer detection on the object to be measured 4.

As shown in FIG. 2, in a case where the object to be measured 4 is present in the sixth range of irradiation 223, the first light-emitting elements 21 emits first signal beams 211 to the first to fourth ranges of irradiation 213, and the presence of the object to be measured 4 in the fourth range of irradiation 213 is identified.

Next, particular second light-emitting elements 22 that emit second signal beams 221 corresponding to the fourth range of irradiation 213 are driven. The fifth and sixth ranges of irradiation 223 (illustrated in FIG. 2) are scanned in sequence by the correspond second light-emitting elements 22. When the sixth range of irradiation 223 is irradiated with a second signal beam 221 emitted by the corresponding second light-emitting element 22, the second signal beam 221 is reflected by the object to be measured 4, and the reflected light is received by the light-detecting element unit 3. The light-detecting element unit 3 receives the second signal beam 221 and outputs a received-light signal. As a result, the object to be measured 4 is detected in the sixth range of irradiation 223.

In the example shown in FIG. 3, it is necessary to emit light a total of twelve times to detect the object to be measured 4. On the other hand, in the example shown in FIG. 2 of the optical sensor 1 according to Embodiment 1, the object to be measured 4 can be detected by emitting light a total of six times. This shows that the amount of time it takes to detect the object to be measured 4 is drastically shortened.

The optical sensor 1 includes a calculator (not illustrated) that calculates the distance to the object to be measured 4 on the basis of a received-light signal outputted by the light-detecting element unit 3. A timing of emission of light by the light-emitting spots 20 of the light-emitting element unit 2 and a timing of reception of a first signal beam 211 or a second signal beam 221 by the light-detecting element unit 3 have a time difference that depends on the distance to the object to be measured 4, and this time difference corresponds to the amount of time it takes for pulsed light to be received by the light-detecting element unit 3 after being reflected by the object to be measured 4. The calculator of the optical sensor 1 can calculate the distance to the object to be measured 4 on the basis of the time difference between the timing of emission and the timing of reception or the like.

Thus, in the optical sensor 1 according to Embodiment 1, the first light-emitting elements 21 and the second light-emitting elements 22, which are different in angle of beam spread from each other, are driven in combination. This makes it unnecessary to perform spatial scanning using all of the light-emitting spots 20 of the light-emitting element unit 2 and makes it possible to identify the distance to the object to be measured 4 by emitting light as small a number of times as possible. This makes it possible to detect the object to be measured 4 with a simple driving system configuration of a combination of the first light-emitting elements 21 and the second light-emitting elements 22, enabling the speeding-up of detection and low-power-consumption detection.

It is preferable that the light-detecting element unit 3 include avalanche photodiodes as light-detecting elements, particularly single-photon avalanche photodiodes (single-photon avalanche diodes; hereinafter referred to as “SPADs”), each of which gives a large output current by effecting an avalanche phenomenon upon receiving a single photon. This makes it possible to detect the distance with resolving power of the order of picoseconds.

Further, it is preferable that the SPADs, which serve as the light-detecting elements of the light-detecting element unit 3, come in two types of light-detecting element, namely a reference light-detecting element that directly receives an emitted pulse and a signal light-detecting element that receives reflected light from the object to be measured 4. This makes it possible, for example, to detect a signal detection time lag between these two types element with a TDC circuit, create, with a histogram circuit, a histogram of signal beams received within a certain period of time of 20 ns, and calculate and output the distance to the object to be measured 4.

### Embodiment 2

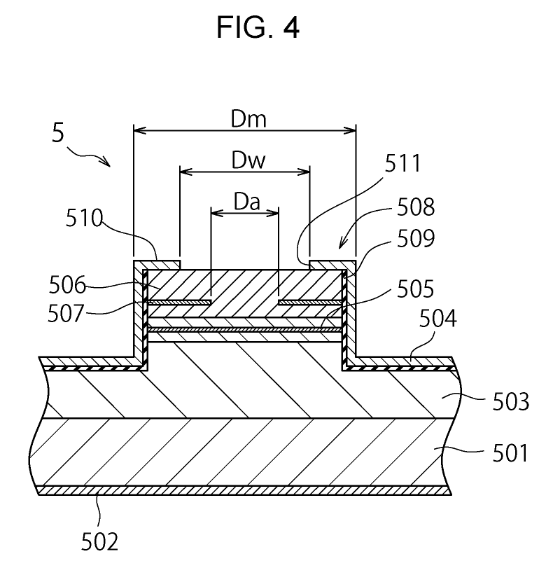

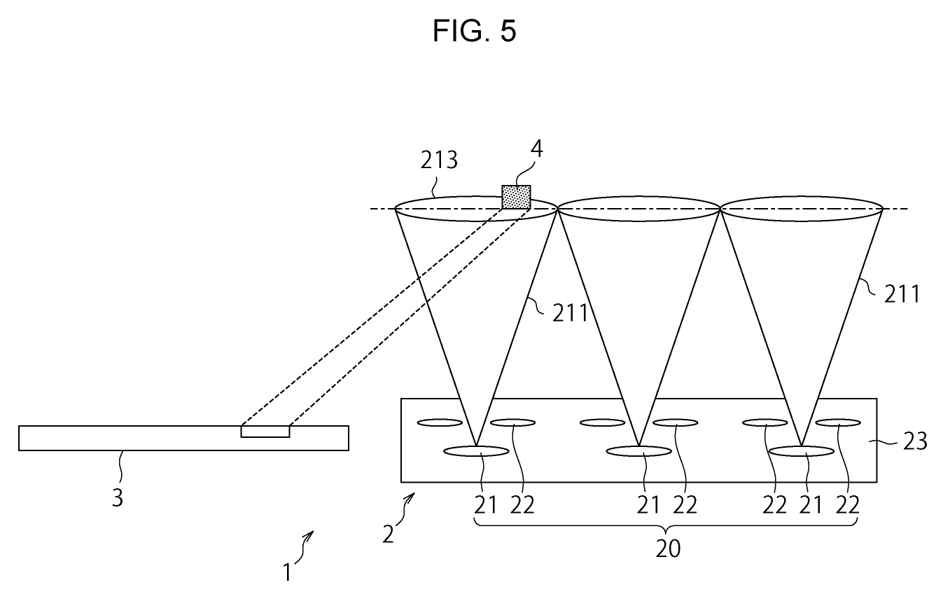

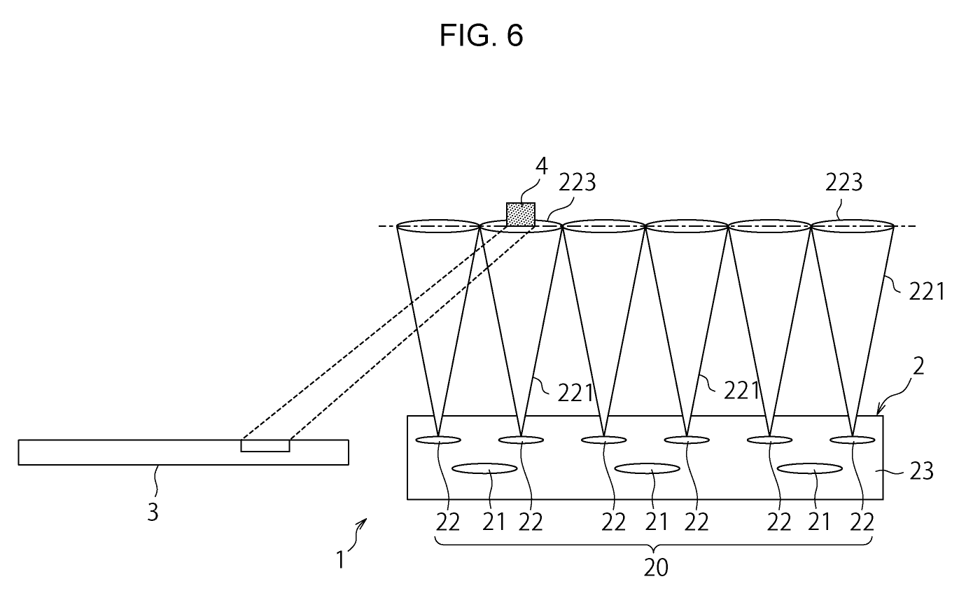

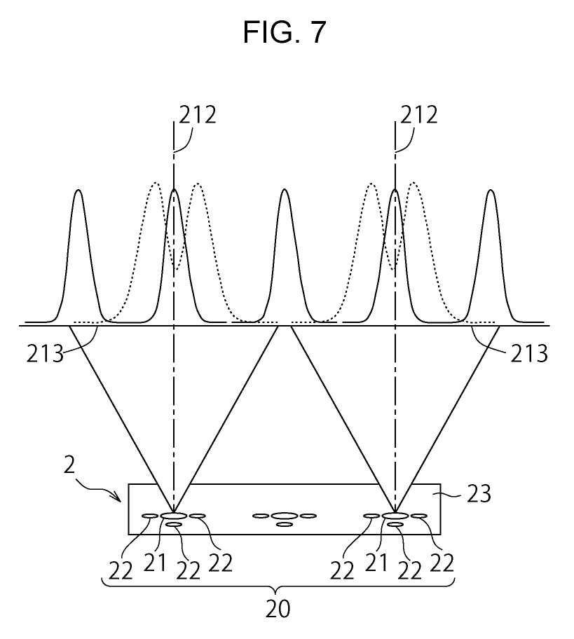

FIGS. 4 to 7 pertain to an optical sensor 1 according to Embodiment 2. FIG. 4 is a cross-sectional view showing an example of a light-emitting spot 20. FIG. 5 is an explanatory diagram schematically showing how first light-emitting elements 21 are driven. FIG. 6 is an explanatory diagram schematically showing how second light-emitting elements 22 are driven. FIG. 7 is an explanatory diagram showing a far-field pattern of light emitted by light-emitting spots 20.

Since the optical sensors 1 according to Embodiments 2 to 5 to be described below are identical in basic configuration to the optical sensor 1 according to Embodiment 1, a detailed description of common components is omitted by using common signs.

It is preferable that the plurality of first light-emitting elements 21 and the plurality of second light-emitting elements 22, which serve as the light-emitting spots 20, be each constituted by a surface-emitting semiconductor laser (vertical-cavity surface-emitting laser; hereinafter referred to as “VCSEL 5”) such as that shown in FIG. 4. The VCSEL 5 has a current-blocking function of enhancing the efficiency of a current that is injected into an active region and a light-confining function of efficiently confining light produced in the active region.

An example of a preferred form of the VCSEL 5 is a mesa-structured selectively-oxidized tubular VCSEL configured such that a current-conducting region (oxidized aperture) surrounded by an oxidized region obtained by selectively oxidizing a semiconductor layer of high Al composition from a mesa side surface contributes to current blocking and light confinement.

For example, as shown in FIG. 4, the VCSEL 5 includes an n-side electrode 502 on a lower surface of an n-type GaAs substrate 501, and furthermore, over the substrate 501, an n-type GaAs buffer layer 503, an n-type lower DBR (distributed Bragg reflector) 504 constituted by a semiconductor multi-layer film composed of a pair of AlGaAs differing in Al composition ratio from each other, an active region 505, and a p-type upper DBR 506 constituted by a semiconductor multi-layer film composed of a pair of AlGaAs differing in Al composition ratio from each other are stacked. The upper DBR 506 partially contains an oxidized layer 507 composed of p-type AlAs.

A post 508, which serves as a laser beam emitter, has a resonator structure of the lower DBR 504 and the upper DBR 506 between which the active region 505 is sandwiched. A current-conducting region that is formed in the oxidized layer 507 is called “oxidized aperture”. At the top of the post 508, an insulating film 509 is partially removed, and a p-type circular upper electrode 510 is formed. In the center of the upper electrode 510, a circular opening 511 that defines a region of emission of a laser beam is formed with a diameter Dw. As a result, the VCSEL 5 forms a vertical resonator with the active region 505 sandwiched over the substrate 501 and emits an ampljfied laser beam in a direction perpendicular to the substrate 501.

In the optical sensor 1, the light-emitting spots 20 have their first and second light-emitting elements 21 and 22 each constituted by appropriately selecting an oxidized aperture diameter Da of the oxidized layer 507 with respect to the post diameter Dm. For example, when the oxidized aperture diameter Da is a large diameter of, for example, 24 μm, the VCSEL 5 can be used as a first light-emitting element 21 that is wide in angle of beam spread. Alternatively, when the oxidized aperture diameter Da is a large diameter of, for example, 8.5 μm, the VCSEL 5 can be used as a second light-emitting element 22 that is narrow in angle of beam spread.

This makes it possible to, as shown in FIGS. 5 and 6, place the first light-emitting elements 21, which are wide in angle of beam spread, and the second light-emitting elements 22, which are narrow in angle of beam spread, on the identical chip 23 of the light-emitting element unit 2 and makes it possible to increase the density of the light-emitting spots 20. This in turn makes it possible to downsize the light-emitting spots 20 as the optical sensor 1 and makes it also possible to reduce errors in the ranges of irradiation 213 and 223 and characteristic errors.

The optical sensor 1 may be configured such that the first light-emitting elements 21 and the second light-emitting elements 22 are simultaneously driven. For example, as shown in FIG. 5, simultaneous driving of the plurality of first light-emitting elements 21 allows the light-detecting element unit 3 to receive a first signal beam 211 emitted by a particular first light-emitting element 21 and output a received-light signal. Further, as shown in FIG. 6, simultaneous driving of the plurality of second light-emitting elements 22 allows the object to be measured 4 to be identified by the light-detecting element unit 3 receiving a second signal beam 221 and outputting a received-light signal.

When the aperture diameter Da of the VCSEL 5 is large, increased driving current brings about a multiple mode that leads to a wider angle of beam spread, but there is concern that the amount of light that is emitted on the optical axis 212 may drop due to a difference in reflectivity between the periphery and center of the range of irradiation 213. However, as shown in FIG. 7, simultaneous driving of the first light-emitting elements 21 and the second light-emitting elements 22 allows the first light-emitting elements 21 to attain a multiple mode (dotted line) having a plurality of peaks in a Gaussian distribution of intensity (far-field pattern; hereinafter referred to as “FFP”) and allows the second light-emitting elements 22 to evenly attain a single mode (solid line) having a single peak in a range of irradiation 213.

Therefore, a combination of the first light-emitting elements 21, which are wide in angle of beam spread, and the second light-emitting elements 22, which are narrow in angle of beam spread, makes it possible to evenly form FFP distributions of intensity. Further, this makes it possible to increase the accuracy of detection in a multiple mode at the time of spatial scanning at wide viewing angles by the first light-emitting elements 21. Furthermore, this makes it also possible to increase the accuracy of detection at narrow viewing angles by the second light-emitting elements 22.

### Embodiment 3

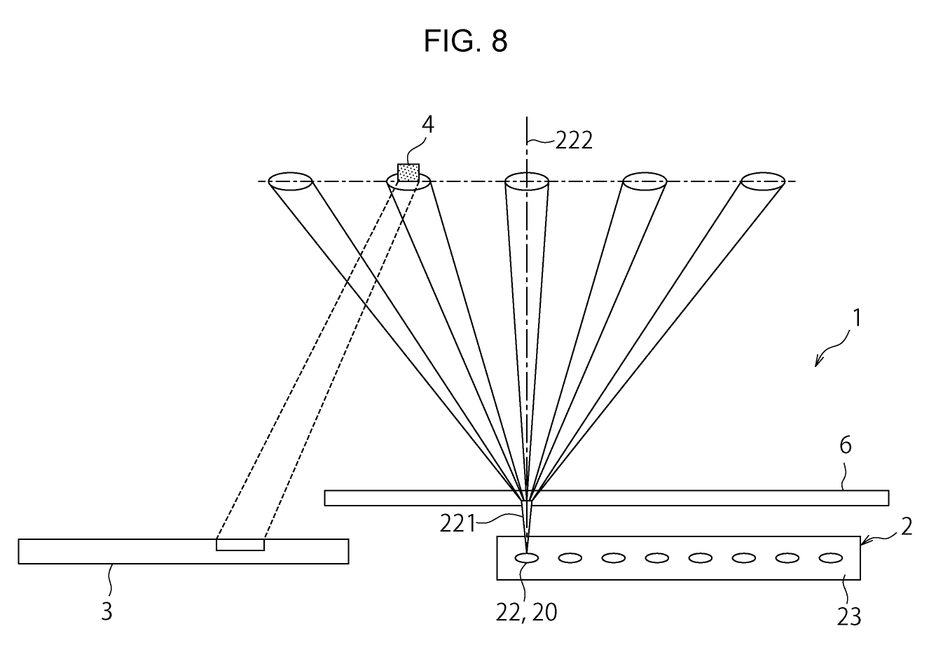

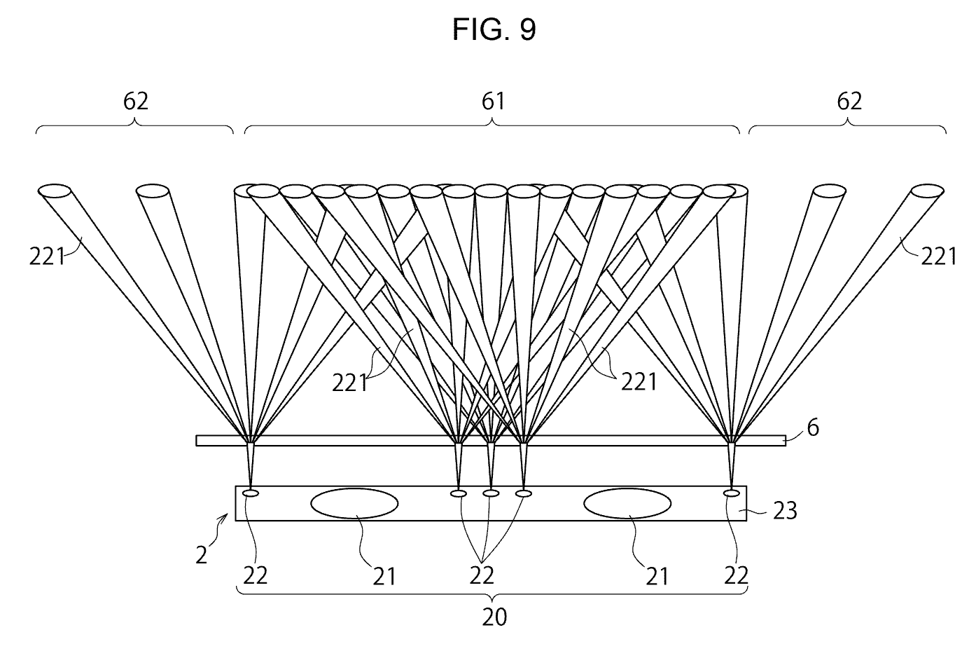

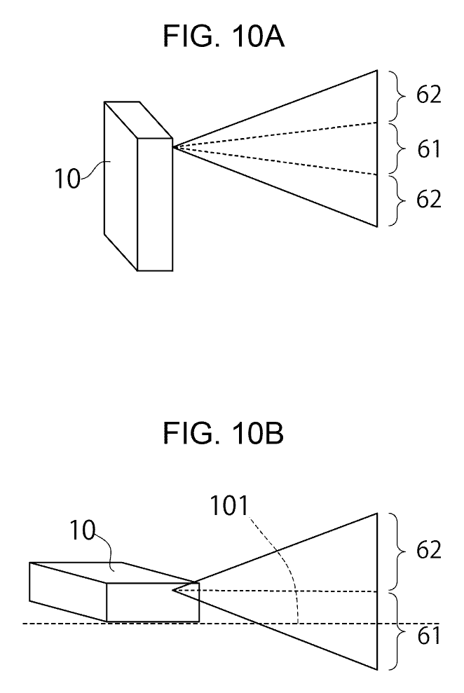

FIGS. 8 and 9 are explanatory diagrams each showing a configuration of an optical sensor 1 according to Embodiment 3, and FIGS. 10A and 10B are explanatory diagrams each showing an example of an electronic apparatus to which the optical sensor 1 is applied. The optical sensor 1 according to Embodiment 3 is configured such that the light-emitting spots 20 of the light-emitting element unit 2 irradiate the object to be measured 4 with light via a photorefractive material 6.

As noted above, the first light-emitting elements 21 and the second light-emitting elements 22 are each constituted by a VOSEL 5 characterized by having a vertical resonator formed with the active region 505 sandwiched over the substrate 501 and emitting an amplified laser beam in a direction perpendicular to the substrate 501.

The photorefractive material 6 is for example disposed to be orthogonal to the optical axes 222 of the second light-emitting elements 22 of the light-emitting spots 20 and to face the chip 23, which is a surface of emission of the second signal beams 221. As shown in FIG. 8, the photorefractive material 6 for example transmits and diffuses a second signal beam 221 emitted from a second light-emitting element 22. Further, the photorefractive material 6 is an optical member that is capable of producing not random diffusion light but angle-dependent diffusion light, and can reduce a loss of the amount of light with which a second signal beam 221 emitted from a second light-emitting element 22 passes through the photorefractive material 6.

A usable example of the photorefractive material 6 is a diffractive-optical element (DOE) or a lens (microlens) that can make a particular diffraction pattern. A second signal beam 221 can be split by the photorefractive material 6 into a plurality of split beams to expand its emitting region. This allows the second light-emitting elements 22 to scan a wider region. The first light-emitting elements 21 of the light-emitting spots 20 can expand their emitting regions in the same manner. This enables the optical sensor 1 to achieve an increase in the density of the light-emitting spots 20 and expand a target range of spatial scanning by the light-emitting spots 20.

In addition, an example of a more preferred form is a configuration such as that shown in FIG. 9. In this case, the light-emitting element unit 2, in which the plurality of first light-emitting elements 21 and the plurality of second light-emitting elements 22 are placed as the light-emitting spots 20, have the plurality of first light-emitting elements 21 evenly placed and have a region where a large number of second light-emitting elements 22 are arrayed and a region where a small number of second light-emitting elements 22 are arrayed.

By having a region where a plurality of second light-emitting elements 22 are densely placed in proximity to each other, the light-emitting element unit 2 can form a dense region 61 where second signal beams 221 split via the photorefractive material 6 are highly densely emitted and sparse regions 62 where second signal beams 221 are comparatively sparsely emitted, enabling detection with higher resolving power. Therefore, the first light-emitting elements 21 of the light-emitting element unit 2 are capable of detection at equal angles and therefore make it possible to grasp a background component such as disturbance light, and the second light-emitting elements 22 of the light-emitting element unit 2 make it possible to detect the object to be measured 4 in detail.

An example of an electronic apparatus 10 to which the optical sensor 1 thus configured is applied is a portable terminal such as a smartphone. In this case, as shown in FIG. 10A, it is preferable that a dense region 61 of second signal beams 221 by second light-emitting elements 22 be disposed near the center of the light-emitting spots 20. This makes it possible to increase resolving power near the center of highly-dense irradiation with the second signal beams 221, allowing suitability for use, for example, in face authentication and camera focus.

Further, as shown in FIG. 10B, in a case where the optical sensor 1 is applied to a robotic cleaner as the electronic apparatus 10, providing a dense region 61 of second signal beams 221 that irradiate an area around a floor surface 101 makes it possible to increase resolving power in the area around the surface floor 101, bringing about improvement, for example, in the accuracy of detection of a step on the floor surface 101.

### Embodiment 4

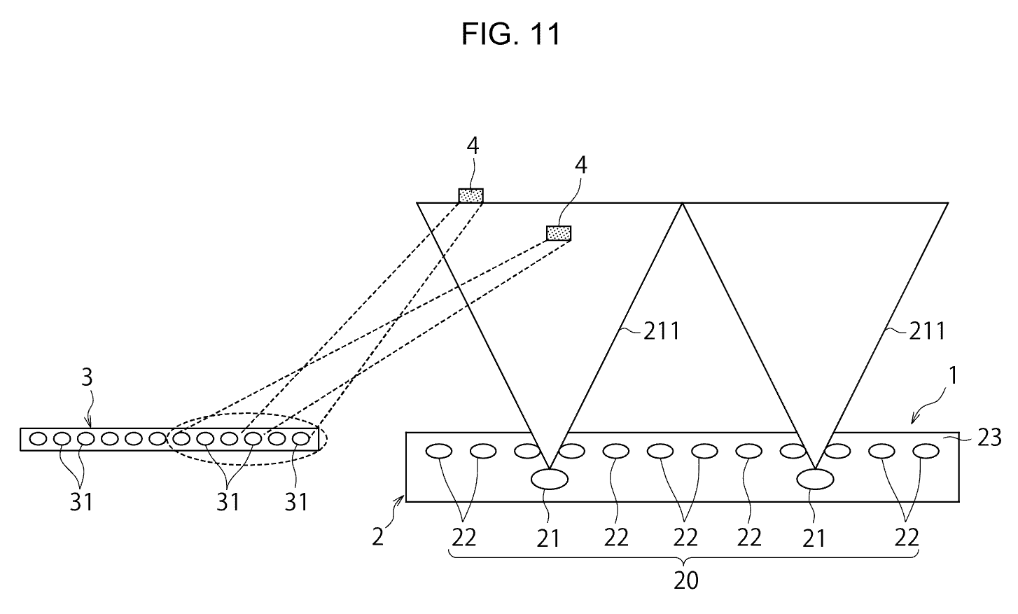

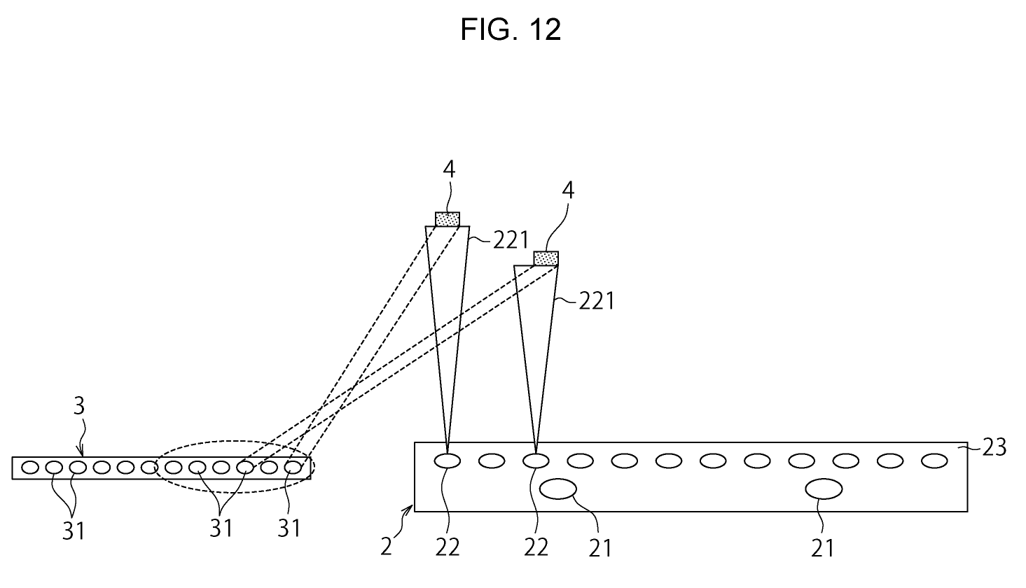

FIGS. 11 and 12 are explanatory diagrams each showing a configuration of an optical sensor 1 according to Embodiment 4. The optical sensor 1 according to Embodiment 4 is configured to include an association between the light-emitting element unit 2 and the light-detecting element unit 3.

The light-detecting element unit 3 includes a plurality of light-detecting elements 31, and SPADs are used as the light-detecting elements 31. In this case, the SPADs are each configured to have an effective diameter of 8 μm to 10 μm so that a large number of light-detecting elements 31 can be disposed in the light-detecting element unit 3. These light-detecting elements 31 are arrayed in association with light-emitting spots 20 of the light-emitting element unit 2 that are driven in sequence.

For example, a plurality of light-detecting elements 31 of the light-detecting element unit 3 are associated with a single first light-emitting element 21 of the light-emitting element unit 2. Further, a plurality of second light-emitting elements 22 of the light-emitting element unit 2 are associate one by one with a plurality of light-detecting elements 31 of the light-detecting element unit 3.

Spatial scanning is described which is performed in a case where two different objects to be measured 4 are present at a distance from each other as shown in FIG. 11. A first signal beam 211 emitted by any of the first light-emitting elements 21 of the light-emitting element unit 2 and reflected by the two objects to be measured 4 is received by the light-detecting element unit 3. In the light-detecting element unit 3, a plurality of light-detecting elements 31 associated with the first light-emitting element 21 that has emitted the first signal beam 211 thus received receive the first signal beam 211 output first received-light signals. As a result, angle distributions formed by the two objects to be measured 4 are grasped.

Next, as shown in FIG. 12, the plurality of corresponding second light-emitting elements 22 are driven on the basis of the first received-light signals outputted by the light-detecting element unit 3. A second signal beam 221 emitted by a second light-emitting element 221 is reflected by one of the objects to be measured 4 and received by a light-detecting element 31 associated with this second light-emitting element 22. Similarly, a second signal beam 221 is reflected by the other object to be measured 4 and received by a light-detecting element 31 associated therewith.

Thus, second signal beams 221 reflected by a plurality of objects to be measured 4 are received by the corresponding light-detecting elements 31, respectively, without affecting each other, and these objects to be measured 4 can be highly accurately detected in a short time.

In the case of a configuration having no association between the light-emitting element unit 2 and the light-detecting element unit 3, there is fear that spatial scanning might be completed upon detection of only one of the objects to be measured 4 when the second light-emitting elements 22 are driven in sequence. On the other hand, Embodiment 4 makes it possible to feed back the angle distributions of the objects to be measured 4 on the basis of the first received-light signals outputted by the light-detecting element unit 3 and narrow down the second light-emitting elements 22 to be driven. Moreover, emission of second signal beams 221 by the second light-emitting elements 22 thus selected makes it possible to detect the plurality of objects to be measured 4 in a short time. This makes it unnecessary to drive all of the second light-emitting elements 22 of the light-emitting element unit 2 and makes it sufficient to drive only selected second light-emitting elements 22, thus making it possible to further lower power consumption.

### Embodiment 5

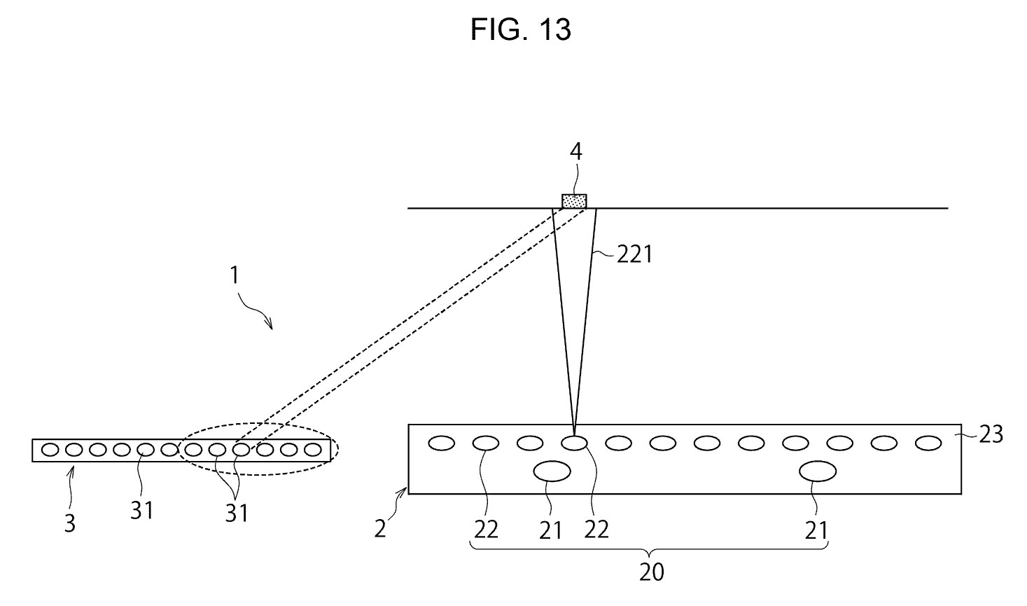

FIG. 13 is an explanatory diagram showing a configuration of an optical sensor 1 according to Embodiment 5. In addition to being configured according to Embodiment 4, the optical sensor 1 according to Embodiment 5 is configured to narrow down the light-detecting elements 31 of the light-detecting element unit 3 that are to be driven.

As noted above, an object to be measured 4 is roughly identified by driving the first light-emitting elements 21, and a second light-emitting element 22 to be driven is selected. In Embodiment 5, furthermore, the light-detecting elements 31 of the light-detecting element unit 3 that are to be driven are limited to a light-detecting element 31 associated with selected second light-emitting element 22.

FIG. 13 uses slanted lines to indicate a limited light-detecting element 31 of the light-detecting element unit 3 that is to be driven in driving a second light-emitting element 22. That is, of the plurality of light-detecting elements 31 of the light-detecting element unit 3, only one light-detecting element 31 associated with a selected second light-emitting element 22 is driven. The light-detecting element 31 indicated by the slanted lines is driven, and the other light-detecting elements 31 are not driven.

Although spatial scanning performed with all of the light-detecting elements 31 driven is susceptible to disturbance noise such as a background and may suffer from a decrease in the accuracy of detection of an object to be measured 4, the accuracy of detection can be improved by narrowing down the target range by associating the light-emitting element unit 2 and the light-detecting element unit 3 with each other as in the case of Embodiment 5. Further, decreasing the number of light-detecting elements 31 to be driven simultaneously with second light-emitting elements 22 at the time of spatial scanning by the optical sensor 1 makes it possible to further lower power consumption. This makes it possible to perform high-speed spatial scanning with low power consumption while keeping the accuracy of detection high.

As described above, an optical sensor 1 and an electronic apparatus 10 according to the present disclosure make it possible to improve resolving power with simple configuration based on spatial scanning by a combination of first light-emitting elements 21 and second light-emitting elements 22, enabling the speeding-up of detection and low-power-consumption detection.

An optical sensor 1 and an electronic apparatus 10 according to the present disclosure are not limited in configuration to those shown in the embodiments described above but may be altered in various ways within the scope of the claims, and an embodiment based on a combination of technical means disclosed is encompassed in the technical scope of the present disclosure. For example, the light-emitting spots 20 of the light-emitting element unit 2 are not limited in configuration to those shown in the embodiments described above, but high-accuracy, high-speed, and low-power-consumption spatial scanning may be performed with a combination of even more first light-emitting elements 21 and second light-emitting elements 22. Therefore, the embodiments described above are merely examples and are not intended to limit the present disclosure.

The present disclosure is suitably applicable to an optical sensor that performs spatial scanning and an electronic apparatus including the same.

The present disclosure contains subject matter related to that disclosed in Japanese Priority Patent Application JP 2018-087342 filed in the Japan Patent Office on Apr. 27, 2018, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An optical sensor comprising:
a light-emitting element unit that emits a signal beam having a predetermined spread centered at a direction of emission; and
a light-detecting element unit that receives a signal beam reflected by an object to be measured,
the optical sensor detecting a distance to the object to be measured on the basis of a signal beam received by the light-detecting element unit,
wherein the light-emitting element unit has a plurality of light-emitting spots arrayed, and
the light-emitting spots include a first light-emitting element and a second light-emitting element that are different in angle of beam spread of the signal beam from each other.

2. The optical sensor according to claim 1, wherein the first light-emitting element and the second light-emitting element are surface-emitting semiconductor lasers arrayed on an identical plane.

3. The optical sensor according to claim 1, wherein the first light-emitting element emits a signal beam that is wider in angle of beam spread than the second light-emitting element.

4. The optical sensor according to claim 3, further comprising a photorefractive material placed in a direction of emission of a signal beam by the light-emitting element unit.

5. The optical sensor according to claim 4, wherein the light-emitting spots include a plurality of the second light-emitting elements and have a dense region where the plurality of second light-emitting elements are densely arrayed and a sparse region where the plurality of second light-emitting elements are sparsely arrayed.

6. The optical sensor according to claim 3, wherein the second light-emitting element is driven after driving of the first light-emitting element.

7. The optical sensor according to claim 3, wherein the light-detecting element unit includes a plurality of light-detecting elements each of which receives a first signal beam emitted by the first light-emitting element or a second signal beam emitted by the second light-emitting element and outputs a received-light signal, and
on the basis of a received-light signal representing the first signal beam, a second light-emitting element whose emission fails within a range of irradiation with the first signal beam is selected and driven.

8. The optical sensor according to claim 7, wherein the light-detecting element unit drives a light-detecting element of the plurality of light-detecting elements that receives a second signal beam from the second light-emitting element selected on the basis of the received-light signal representing the first signal beam.

9. An electronic apparatus comprising the optical sensor according to claim 1.
